(19) United States
(12) Patent Application Publication
(10) Pub. No.: US 2007/0003295 A1
(43) Pub. Date: Jan. 4, 2007

(54) Image-processing device, image forming device, electronic equipment, and image forming method

(76) Inventor: Kenichi Morimoto, Kyoto (JP)

Correspondence Address: BIRCH STEWART KOLASCH & BIRCH, PO BOX 747, FALLS CHURCH, VA, 22040-0747, US

(21) Appl. No.: 10/562,145

(22) PCT Filed: Jun. 25, 2004
(86) PCT No.: PCT/JP04/09400

§ 371 Date: Dec. 23, 2005

(30) Foreign Application Priority Data
Jun. 27, 2003 (JP) 2003-185361

(51) Int. Cl. G03G 15/00

(52) U.S. Cl. 399/16

(57) ABSTRACT

An image forming apparatus includes an image forming system having a pickup roller (36a) that extracts and supplies a recording paper (P) housed in a paper cassette (33), a photosensitive drum (31b) that forms an image on the recording paper (P) supplied by the pickup roller (36a), and the like. In the case that multi-feeding has occurred in which when the pickup roller (36a) supplies a first recording paper (P1) another recording paper (P2) is also supplied, and the first recording paper (P1) is between the photosensitive drum (31b) and the other recording paper (P2), image forming processing for the first recording paper (P1) by the image forming system is continued.

### TECHNICAL FIELD

The present invention relates to an image processing apparatus, an image forming apparatus, an electronic equipment, and an image forming method, provided with a function that detects multi-feeding in which paper such as recording paper loaded on a placement stage is fed in a state with two or more pages stacked.

### BACKGROUND ART

A scanner apparatus, copy apparatus, facsimile apparatus, or a multifunction machine in which any of these apparatuses are combined is provided with an original reading apparatus for reading image information of an original, and an image forming apparatus for forming a toner image on a photosensitive drum based on image information of the read original and transferring the toner image to recording paper.

In this case, in the image forming apparatus, when feeding recording paper page by page from a plurality of pages of recording paper that have been placed on a placement stage and transporting the supplied recording paper to an image forming portion constituted from a photosensitive drum or the like, two or more pages of recording paper may be supplied stacked together due to friction or the like between pages of recording paper piled on the placement stage. In this case, depending on the feed method and the feed structure (such as straight feed or reverse feed), when image forming, an image is formed straddling the plurality of pages of recording paper that have been multi-fed, and so there was the problem that image defects and waste of recording paper occurred.

Consequently, image forming apparatuses provided with a means for solving such problems have been proposed in the conventional technology.

For example, image forming apparatuses have been proposed with a configuration in which duplex copy, simplex copy, and multiple copy modes are provided, in the simplex copy mode the copy operation is continued even if multi-feeding of recording paper is detected, and a notification is made of the page number when multi-feeding occurs (For example, see JP S61-113076A. Hereinafter, referred to as “Patent Document 1”.).

Image forming apparatuses have also been proposed with the following configuration. When recording paper has been multi-fed, only the transport operation of that recording paper is permitted, the output of image data to the corresponding recording paper is prohibited, and when the next recording paper has been normally separated and transported, the recording paper transport operation and output of image data are allowed. By separating the multi-fed recording paper to a vacant tray as a blank page, defective printing is prevented and multi-fed recording paper is separated (For example, see JP H7-140854A. Hereinafter, referred to as “Patent Document 2”.).

Further, image forming apparatuses have also been proposed with a configuration in which, by printing to only the final recording paper when recording paper has been multi-fed, the waste of recording paper and printing time is reduced (For example, see JP H7-125351A. Hereinafter, referred to as “Patent Document 3”.).

With the technology disclosed in above Patent Document 1, when simplex printing is performed, all printing is performed regardless of the state of multi-feeding. However, when the feed mechanism is a top-intake reverse feed mechanism, for example, the recording paper that has been multi-fed becomes positioned between the image forming portion and the recording paper on which an image should be formed, and in this case the problem occurs that printing is performed with the print image divided onto a plurality of pages of recording paper. That is, in the configuration disclosed in Patent document 1, because the relationship of the multi-feeding state with the structure of the mechanism of the image forming portion and the feed method is not considered at all, the sort of problem described above occurs.

Also, with the technology disclosed in above Patent Document 2, a configuration is adopted in which, when recording paper has been multi-fed, only the transport operation of that recording paper is permitted, and the output of image data to the recording paper is prohibited. However, there was the problem that the recording paper for which printing is not performed may be unusable, due to the occurrence of affixing paper dust in the image forming portion by allowing recording paper for which printing is not performed to pass the image forming portion, affixing fixing oil by allowing the recording paper to pass the fixing portion, curling due to heat, and the like.

Further, with the technology disclosed in above Patent Document 3, a configuration is adopted in which printing is performed on the final recording paper when recording paper has been multi-fed, but when the feed mechanism is a top-intake straight feed mechanism, for example, the other multi-fed recording paper or the initial recording paper on which an image should be formed become positioned on the recording face side of the final recording paper, and so the problem occurs that like described above, printing is performed with the print image divided onto a plurality of pages of recording paper. That is, in the configuration disclosed in Patent Document 3, because the relationship of the multi-feeding state with the structure of the mechanism of the image forming portion and the feed method is not considered at all, the sort of problem described above occurs.

### DISCLOSURE OF INVENTION

The present invention was made in consideration of the problems described above, and it is an object thereof to provide an image processing apparatus, image forming apparatus, electronic equipment, and image forming method in which, in the case that multi-feeding of recording paper has occurred, by considering the structure of the mechanism of the image forming portion, feed method, and the like, it is possible to appropriately execute continuation and prohibition of image formation in response to the multi-fed state.

An image processing apparatus according to the present invention includes a paper transport system that transports paper and an image processing system that performs image forming processing for paper transported by the paper transport system, and when, in the case that multi-feeding has occurred in which when a first paper is transported by the paper transport system another paper is also transported, and the other paper is not positioned between the first paper and a working portion of the image processing system, the working portion of the image processing system is allowed to operate.

Alternatively, an image forming apparatus according to the present invention includes a recording paper transport system that transports recording paper and an image forming system that forms an image on recording paper transported by the recording paper transport system, and when, in the case that multi-feeding has occurred in which when a first recording paper is transported by the recording paper transport system another recording paper is also transported, and the other recording paper is not positioned between the first recording paper and an image forming portion of the image forming system, image forming processing for the first recording paper by the image forming system is continued.

Alternatively, an image forming apparatus according to the present invention includes a movable feed member that supplies recording paper by making contact with recording paper that has been placed on a placement stage and extracting that recording paper from the placement stage with frictional force between the feed member and the contacted recording paper, and an image forming system that forms an image on the recording paper supplied by the feed member, and when, in the case that multi-feeding has occurred in which when a first recording paper is transported by the feed member another recording paper is also supplied, and the contact face of the first recording paper contacted by the feed member is the image forming face, image forming processing for the first recording paper by the image forming system is continued. Also, an image forming apparatus according to the present invention includes a movable feed member that supplies recording paper by making contact with recording paper that has been placed on a placement stage and extracting that recording paper from the placement stage with frictional force between the feed member and the contacted recording paper, and an image forming system that forms an image on the recording paper supplied by the feed member, and when, in the case that multi-feeding has occurred in which when a first recording paper is transported by the feed member another recording paper is also supplied, and the contact face of the first recording paper contacted by the feed member is not the image forming face, image forming processing for the other recording paper by the image forming system is continued.

According to an image forming apparatus having this sort of configuration, the operation of the apparatus is not stopped even in the case that recording paper, which is paper, has been multi-fed, and so it is possible to improve job efficiency. Also, when operation of the apparatus is stopped due to multi-feeding, recording paper accumulates in the apparatus and wasteful work such as the removal of recording paper (jam processing) is generated for the operator, but it is possible to decrease this sort of wasteful work. Further, it is possible to prevent damage to a photosensitive drum or transfer apparatus by jam processing, and pollution inside the apparatus such as unfixed toner can be prevented.

Alternatively, an image forming apparatus according to the present invention includes a recording paper transport system that transports recording paper and an image forming system that forms an image on recording paper transported by the recording paper transport system, and when, in the case that multi-feeding has occurred in which when a first recording paper is transported by the recording paper transport system another recording paper is also transported, and the other recording paper is positioned between the first recording paper and an image forming portion of the image forming system, image forming processing for the first recording paper by the image forming system is prohibited.

Alternatively, an image forming apparatus according to the present invention includes a movable feed member that supplies recording paper by making contact with recording paper that has been placed on a placement stage and extracting that recording paper from the placement stage with frictional force between the feed member and the contacted recording paper, and an image forming system that forms an image on the recording paper supplied by the feed member, and when, in the case that multi-feeding has occurred in which when a first recording paper is transported by the feed member another recording paper is also supplied, the contact face of the first recording paper contacted by the feed member is not the image forming face, image forming processing for the first recording paper by the image forming system is prohibited.

According to an image forming apparatus having this sort of configuration, in the case that the other recording paper is positioned between the first recording paper and the image forming portion of the image forming system, that is, when the contact face of the first recording paper contacted by the feed member is not the image forming face, and image formation is continued, the image is divided and also formed on the multi-fed recording paper, and a good image can not be obtained, but by prohibiting image formation it is possible to decrease wasteful consumption of feed.

A configuration may also be adopted in which, in the image forming apparatus of the present invention, a detector that detects multi-feeding of the first recording paper and the other recording paper is provided between the placement stage of the recording paper and the image forming portion of the image forming system. In this case, the detector detects multi-feeding by detecting an edge portion of the multi-fed other recording paper.

According to an image forming apparatus having this sort of configuration, it is possible to detect multi-feeding of the recording paper before it arrives at the image forming portion, and so it becomes possible to judge whether or not image formation will be continuously performed, and to perform control suited to the multi-fed state when image formation is performed in the multi-fed state, and so a good image is obtained when image formation has been performed.

A configuration may also be adopted in which, in the image forming apparatus of the present invention, a transfer bias is increased from the normal transfer bias when performing image formation in the case that multi-feeding has occurred. Thus, toner on a photosensitive drum, which is the image forming portion, is stably transferred to the recording paper even for a halftone image or the like, and so stable image formation can be performed and it is possible to obtain a good image.

A configuration may also be adopted in which, in the image forming apparatus of the present invention, a fixing temperature is increased from the normal fixing temperature when performing image formation in the case that multi-feeding has occurred. Thus stable fixing is possible in a fixer.

A configuration may also be adopted in which, in the image forming apparatus of the present invention, a trailing edge detector is provided that detects the trailing edge of the recording paper, and when image formation is performed in the case that multi-feeding has occurred, the detection information of the trailing edge of the recording paper from the trailing edge detector is treated as void. A configuration may also be adopted in which, in the image forming apparatus of the present invention, when image formation is performed in the case that multi-feeding has occurred, a reference for judging the occurrence of defects based on the detection information of the trailing edge of the recording paper from the trailing edge detector is changed to a reference taking into consideration the extent of multi-feeding.

According to an image forming apparatus having this sort of configuration, in the case that image formation is performed for multi-fed recording paper, it is possible to prevent erroneous detection related to recording paper transport. That is, when there is multi-feeding, because the length of the transported recording paper increases to the extent of multi-feeding, although the timing of detection of the trailing edge of the recording paper by the trailing edge detector is delayed to that extent and erroneous detection is possible, in the present invention, by either treating the trailing edge detection information as void or adopting a judgment reference that has taken the extent of multi-feeding into consideration in the case of multi-feeding, it is possible to reliably prevent this sort of erroneous detection.

A configuration may also be adopted in which, in the image forming apparatus of the present invention, a notifier is provided that, in the case that multi-feeding has been detected by the detector, makes such a notification. In this case, the notifier makes a notification of information of the recording paper for which image formation could not be performed due to multi-feeding. In this way, by notifying the operator of information of the recording paper for which image formation could not be performed due to multi-feeding (for example, what page number from the beginning, or what page number), it is possible to clearly indicate to the user the presence of recording paper for which image formation could not be performed.

Alternatively, an image forming method according to the present invention includes a step of transporting recording paper page by page with a recording paper transport system, a step of detecting multi-feeding by detecting another recording paper when transporting a first recording paper, and a step of continuing an image forming operation for the first recording paper by the image forming system in the case that the other recording paper is not positioned between the first recording paper and the image forming portion of the image forming system, even in the case that multi-feeding has been detected.

Alternatively, an image forming method according to the present invention includes a step of transporting recording paper page by page with a recording paper transport system, a step of detecting multi-feeding by detecting another recording paper when transporting a first recording paper, and a step of continuing an image forming operation for the other recording paper by the image forming system in the case that multi-feeding has been detected and the other recording paper is positioned between the first recording paper and the image forming portion of the image forming system.

According to an image forming method having this sort of configuration, the operation of the apparatus is not stopped even in the case that the recording paper, which is paper, has been multi-fed, and so it is possible to improve job efficiency. Also, when operation of the apparatus is stopped due to multi-feeding, recording paper accumulates in the apparatus and wasteful work such as the removal of recording paper (jam processing) is generated for the operator, but it is possible to decrease this sort of wasteful work. Further, it is possible to prevent damage to the photosensitive drum or transfer apparatus by jam processing, and pollution inside the apparatus such as unfixed toner can be prevented.

### BRIEF DESCRIPTION OF DRAWINGS

FIG. 1 is a schematic view that shows the internal configuration of a multifunction machine as the image forming apparatus of the present invention.

FIG. 2 is a functional block diagram that shows the basic configuration of a control system of a multifunction machine of the present embodiment.

FIG. 3 is schematic view that shows a state in which, in a process of transporting recording paper housed in a paper cassette to a photosensitive drum of an image forming portion by transporting the recording paper through a transport path having a straight path configuration, recording paper is multi-fed.

FIG. 4 is a schematic view that shows a state in which, in a process of transporting recording paper housed in a paper cassette to a photosensitive drum of an image forming portion by transporting the recording paper through a U-shaped reverse transport path, recording paper is multi-fed.

FIG. 5 is a schematic view that shows a state in which, in a process of transporting recording paper placed in a manual tray to a photosensitive drum of an image forming portion by transporting the recording paper through a U-shaped reverse transport path, recording paper is multi-fed.

FIG. 6 is an explanatory diagram that shows a state in which recording paper has been multi-fed when recording paper housed in a paper cassette is supplied by a pickup roller.

FIG. 7(a) is an explanatory diagram that shows a state in which an image has been formed on recording paper that has been multi-fed.

FIG. 7(b) is an explanatory diagram that shows another state in which an image has been formed on recording paper that has been multi-fed.

FIG. 8 is an outline flowchart of an image forming operation when multi-feeding occurs in Example 1.

FIG. 9 is an outline flowchart of an image forming operation when multi-feeding occurs in Example 2.

FIG. 10 is an outline flowchart of an image forming operation when multi-feeding occurs in Example 3.

### BEST MODE FOR CARRYING OUT THE INVENTION

Hereinafter, the present invention will be described by way of illustrative embodiments with reference to the drawings.

In the present embodiment, a case is described in which the image forming apparatus of the present invention is applied in a multifunction machine.

—Description of the Overall Configuration of the Multifunction Machine—

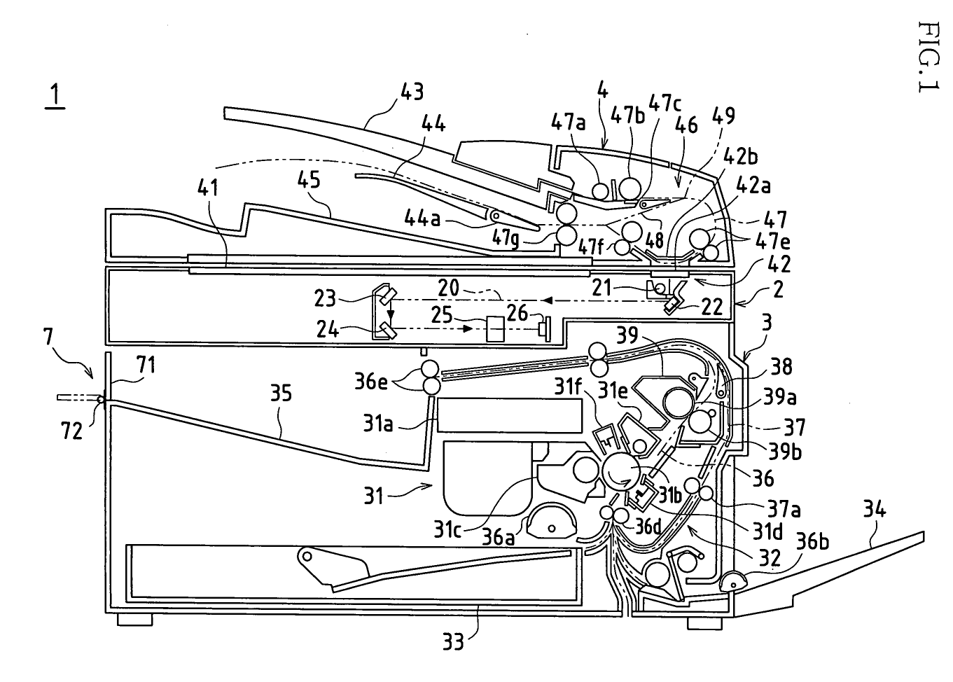

FIG. 1 shows an overview of the internal configuration of a multifunction machine 1 as an image forming apparatus according to the present embodiment. The multifunction machine 1 includes a copier mode, printer mode, and fax mode as image forming modes in which an image is formed on recording paper (including recording media for overhead projectors and the like), and the modes are selected by a user.

This multifunction machine 1 is provided with a scanner portion 2 as an original reading portion, image forming portion 3, and an automatic original feed portion 4. Following is a description of each portion.

<Description of the Scanner Portion 2>

The Scanner Portion 2 reads an image of an original that has been placed on an original stage 41 made from transparent glass or the like, or an image of originals supplied page by page by the automatic original feed portion 4, and creates image data. This scanner portion 2 includes an exposing light source 21, a plurality of reflecting mirrors 22, 23, and 24, an imaging lens 25, and a photoelectric transducer (CCD: Charge Coupled Device) 26.

The exposing light source 21 irradiates light to an original that has been placed on the original stage 41 of the automatic original feed portion 4 or an original that is transported through the automatic original feed portion 4. In the manner of an optical path 20 shown in FIG. 1, the reflecting mirrors 22, 23, and 24 reflect reflected light from the original in the leftward direction in the diagram, then reflect that light downward, then reflect that light in the rightward direction in the diagram towards the imaging lens 25.

As an original image reading operation, when an original has been placed on the original stage 41 (when used as a “stationary sheet system”), the exposing light source 21 and the reflecting mirrors 22, 23, and 24 scan in the horizontal direction along the original stage 41, and read an image of the entire original. On the other hand, when reading an original that is transported through the automatic original feed portion 4 (when used as a “moving sheet system”), the exposing light source 21 and the reflecting mirrors 22, 23, and 24 are fixed in the position shown in FIG. 1, and when the original passes an original reading portion 42 of the automatic original feed portion 4 described below, an image of that original is read.

Light that has been reflected by the reflecting mirrors 22, 23, and 24 and has passed the imaging lens 25 is guided to the photoelectric transducer 26, and in this photoelectric transducer 26 the reflected light is converted to an electrical signal (original image data).

<Description of the Image Forming Portion 3>

The image forming portion 3 includes an image forming system 31 and a paper transport system 32.

The image forming system 31 includes a laser scanning unit (LSU) 31a and a photosensitive drum 31b as a drum-type image carrier. The laser scanning unit 31a irradiates the surface of the photosensitive drum 31b with laser light based on the original image data that has been converted in the photoelectric transducer 26. The photosensitive drum 31b rotates in the direction indicated by the arrow in FIG. 1, and by laser light being irradiated from the laser scanning unit 31a, an electrostatic latent image is formed on the surface of the photosensitive drum 31b.

Other than the laser scanning unit 31a, a development apparatus (development mechanism) 31c, a transfer unit (transfer mechanism) 31d, a cleaning apparatus (cleaning mechanism) 31e, an unshown charge removal unit, and a charging unit 31f are disposed in order in the circumferential direction around the outer circumference of the photosensitive drum 31b. The development apparatus 31c develops the electrostatic latent image that has been formed on the surface of the photosensitive drum 31b into a visible image with toner (manifesting agent). The transfer unit 31d transfers the toner image that has been formed on the surface of the photosensitive drum 31b to recording paper as a recording medium. The cleaning apparatus 31e removes toner remaining on the surface of the photosensitive drum 31b after toner transfer. The charge removal unit removes an electrical charge remaining on the surface of the photosensitive drum 31b. The charging unit 31f charges the surface of the photosensitive drum 31b to a predetermined potential before an electrostatic latent image is formed.

Thus, when forming an image on recording paper, the surface of the photosensitive drum 31b is charged to a predetermined potential by the charging unit 31f, and the laser scanning unit 31a irradiates laser light based on the original image data to the surface of the photosensitive drum 31b. Afterwards, the development apparatus 31c develops a visible image on the surface of the photosensitive drum 31b with toner, and a toner image is transferred to the recording paper by the transfer unit 31d. Afterwards, the toner remaining on the surface of the photosensitive drum 31b is removed by the cleaning apparatus 31e, and the electrical charge remaining on the surface of the photosensitive drum 31b is removed by the charge removal unit. By doing so, one cycle of the operation that forms an image on the recording paper (print operation) is concluded. By repeating this cycle, it is possible to successively form images on a plurality of pages of recording paper.

On the other hand, the paper transport system 32 allows image formation by the image forming system 31 to be performed by transporting recording paper housed in the paper cassette 33 as a paper housing portion or recording paper placed in the manual tray 34 page by page, and discharges recording paper for which image formation has been performed to a discharge tray 35 as a paper discharge portion.

This paper transport system 32 includes a main transport path 36 and a reverse transport path 37. One end of the main transport path 36 is branched into two, with one branch end facing the discharge side of the paper cassette 33 and the other branch end facing the discharge side of the manual tray 34. The other end of the main transport path 36 faces the discharge tray 35. One end of the reverse transport path 37 is connected to the main transport path 36 on the side upstream (below, in the figure) from the position where the transfer unit 31d is disposed, and the other end is connected to the main transport path 36 on the side downstream (above, in the figure) from the position where the transfer unit 31d is disposed.

A pickup roller 36a with a semicircular-shaped cross section is disposed at one branch end (the portion facing the discharge end of the paper cassette 33) of the main transport path 36. When this pickup roller 36a rotates, it makes contact with the topmost recording paper housed in the paper cassette 33. When doing so, the movement of the pickup roller 36a is transmitted to that recording paper by the frictional force between the pickup roller 36a and the recording paper with which it is in contact, and that recording paper is extracted from the paper cassette 33. In this manner, it is possible to intermittently feed the recording paper housed in the paper cassette 33 page by page to the main transport path 36. Likewise, a pickup roller 36b with a semicircular-shaped cross section is disposed at the other branch end (the portion facing the discharge end of the manual tray 34) of the main transport path 36. Due to rotation of this pickup roller 36b, it is possible to intermittently feed the recording paper placed in the manual tray 34 page by page to the main transport path 36.

Registration rollers 36d are disposed on the side upstream from the position where the transfer unit 31d is disposed in this main transport path 36. These registration rollers 36d transport recording paper while matching the positions of the recording paper and the toner image on the surface of the photosensitive drum 31b.

On the side further upstream than the position at which the registration rollers 36d are disposed and downstream from the branch portion of the main transport path 36, a paper detector 36c is disposed that detects an edge portion of the transported recording paper. The paper detector 36c serves as a multi-feeding detector that detects multi-feeding of the recording paper, described below, and as a trailing edge detector that detects the trailing edge of the recording paper.

On the downstream side of the position at which the transfer unit 31d is disposed in the main transport path 36, a fixing apparatus 39 is disposed that is provided with a pair of fixing rollers 39a and 39b for fixing the toner image transferred to the recording paper with heat. Further, at the downstream end of the main transport path 36, discharge rollers 36e are disposed for discharging the recording paper to the discharge tray 35.

A branch catch 38 is disposed at the position connecting the upstream end of the reverse transport path 37 to the main transport path 36. This branch catch 38 is rotatable around a horizontal axis between a first position shown by a solid line in FIG. 1 and a second position that opens the reverse transport path 37 by rotating from the first position in the counterclockwise direction in the figure. When this branch catch 38 is in the first position, the recording paper is transported toward the discharge tray 35, and when the branch catch 38 is in the second position, the recording paper can be supplied to the reverse transport path 37. Transport rollers 37a are disposed in the reverse transport path 37, and in the case that the recording paper has been supplied to the reverse transport path 37 (in the case that the recording paper has been supplied to the reverse transport path 37 by so-called switchback transport), the recording paper is transported by these transport rollers 37a, and again transported through the main transport path 36 toward the transfer unit 31d by being reversed on the upstream side of the registration rollers 36d. That is, it becomes possible to form an image on the rear face of the recording paper.

In the image forming portion 3 with the above configuration, the paper cassette 33, the manual tray 34, the pickup rollers 36a and 36b, the paper detector 36c, and the registration rollers 36d are together also referred to hereinafter as a recording paper feed portion.

<Description of the Automatic Original Feed Portion 4>

Following is a description of the automatic original feed portion 4. This automatic original feed portion 4 is configured as a so-called automatic duplex original transport apparatus. This automatic original feed portion 4 can be used as a moving sheet system, and includes an original tray 43 as an original placement portion, a middle tray 44, an original discharge tray 45 as an original discharge portion, and an original transport system 46 that transports an original between the trays 43, 44, and 45.

The original transport system 46 is provided with a main transport path 47 for transporting an original that has been placed on the original tray 43 to the middle tray 44 or the original discharge tray 45 via an original reading portion 42, and a sub transport path 48 for feeding an original on the middle tray 44 to the main transport path 47.

An original pickup roller 47a and a separation roller 47b are disposed at the upstream end (the portion facing the discharge side of the original tray 43) of the main transport path 47. A separation plate 47c is disposed on the bottom side of the separation roller 47b, and one page of the originals on the original tray 43 is supplied to the main transport path 47 by passing between this separation roller 47b and the separation plate 47c along with rotation of the original pickup roller 47a. PS rollers 47e are disposed on the downstream side of a linking portion 49 of the main transport path 47 and the sub transport path 48. These PS rollers 47e adjust the leading edge of the original and the image reading timing of the scanner portion 2 and feed the original to the original reading portion 42. That is, these PS rollers 47e temporarily stop transport of the original with the original in a supplied state, adjust the above timing, and feed the original to the original reading portion 42.

The original reading portion 42 is provided with a glass platen 42a and an original pressing plate 42b, and when the original supplied from the PS rollers 47e passes between the glass platen 42a and the original pressing plate 42b, light from the exposing light source 21 passes through the glass platen 42a and is irradiated onto the original. At this time, the acquisition of original image data by the scanner portion 2 is performed. Biasing force is conferred on the back face (top face) of the original pressing plate 42b by a coil spring not shown in the figure. Thus, the original pressing plate 42b is in contact with the glass platen 42a with a predetermined pressure, and when the original passes the original reading portion 42, the original is prevented from rising up from the glass platen 42a.

Transport rollers 47f and original discharge rollers 47g are provided on the downstream side of the glass platen 42a. A configuration is adopted in which an original that has passed the glass platen 42a is discharged to the middle tray 44 or the original discharge tray 45 via the transport rollers 47f and the original discharge rollers 47g.

A middle tray swing plate 44a is disposed between the original discharge rollers 47g and the middle tray 44. This middle tray swing plate 44a swings centered on the edge portion of the middle tray 44 side, and can swing between a normal position shown by a solid line in the figure and a flipped up position flipped upward from the normal position. When the middle tray swing plate 44a is in the flipped up position, an original that has been discharged from the original discharge rollers 47g is recovered to the original discharge tray 45. On the other hand, when the middle tray swing plate 44a is in the normal position, an original that has been discharged from the original discharge rollers 47g is discharged to the middle tray 44. When discharging to this middle tray 44, the marginal edge of the original is in a state sandwiched between the original discharge rollers 47g, the original is supplied to the sub transport path 48 by the reverse rotation of the original discharge rollers 47g from this state, and the original is again fed out to the main transport path 47 via this sub transport path 48. This reverse rotation operation of the original discharge rollers 47g is performed after adjusting the timing for feeding out the original to the main transport path 47 and the image reading. Thus, an image of the rear face of the original is read by the original reading portion 42.

—Description of the Basic Operation of the Multifunction Machine—

As the operation of the multifunction machine 1 configured in the manner described above, first, when the multifunction machine 1 functions as a printer (printer mode), it receives print data (image data or text data) that has been transmitted from a host apparatus such as a personal computer, and temporarily stores this received print data in a buffer (memory) not shown in the figure. Along with storing the print data in this buffer, the print data is sequentially read from the buffer, and based on this read print data, an image is formed on recording paper by the image forming operation of the image forming portion 3 described above.

Also, when the multifunction machine 1 functions as a scanner (fax mode), scan image data of an original that has been read by the scanner portion 2 is temporarily stored in the buffer. Along with storing the scan image data in this buffer, the scan image data is sequentially transmitted to a host apparatus from the buffer, and an image is displayed on a display or the like of this host apparatus.

Further, when the multifunction machine 1 functions as a copy machine (copier mode), an image is formed on recording paper by the image forming operation of the image forming portion 3 based on the original image data that has been read by the scanner function.

Following is a description of the copier mode in more detail.

—Description of the Image Forming Operation in the Copier Mode—

When copying the image of an original to recording paper in the copier mode, after placing the original wished to be copied on the original stage 41 of the scanner portion 2 or in the original tray 43, settings are input for the number of pages to print, the print magnification, and the like by depressing input keys provided in an operating panel portion not shown in the figure, and the copy operation is started by depressing a start key not shown in the figure.

When the start key is pressed, in the multifunction machine 1, the pickup roller 36a or 36b rotates and recording paper is supplied to the main transport path 36 from the paper cassette 33 or the manual tray 34. The supplied recording paper is transported to the registration rollers 36d provided on the main transport path 36. The leading edge portion in the transport direction of the recording paper that has been transported to the registration rollers 36d is chucked by the registration rollers 36d such that the sub scanning direction of the recording paper and the axial direction of the registration rollers 36d are parallel, in order to match its position to the position of the toner image formed on the photosensitive drum 31b that should be transferred to the paper.

After image processing has been performed with conditions that have been input using input keys or the like, the image data read by the scanner portion 2 is transmitted to the laser scanning unit 31a as print data. The laser scanning unit 31a forms an electrostatic latent image on the surface of the photosensitive drum 31b, which has been charged to a predetermined potential by the charger 31f, by irradiating laser light based on the image data via a polygon mirror and various lenses not shown in the figure.

Afterwards, toner affixed to the surface of an MG roller 31c1 that faces the photosensitive drum 31b provided in an unshown developer tank of the development apparatus 31c is attracted to and affixes to the surface of the photosensitive drum 31b according to the potential gap on the surface of the photosensitive drum 31b, so that an electrostatic latent image is made as a development. The toner remaining on the photosensitive drum 31b is scraped off by a cleaning blade of a drum unit not shown in the figure, and recovered by a cleaner unit not shown in the figure.

Next, the positions of the recording paper chucked by the registration rollers 36d and the toner image formed on the surface of the photosensitive drum 31b are matched (timing is adjusted) by the registration rollers 36d, and the recording paper is transported between the photosensitive drum 31b and the transfer unit 31d. Then, the toner image on the surface of the photosensitive drum 31b is transferred to the recording paper using an unshown transfer roller provided in the transfer unit 31d.

Heat and pressure are added to the recording paper for which transfer of the toner image is completed due to the recording paper passing between the fixing rollers 39a and 39b of the fixing apparatus 39, the toner image is fused and firmly fixed, and the recording paper is discharged to the discharge tray 35 by the discharge rollers 36e.

—Block Configuration of the Control System—

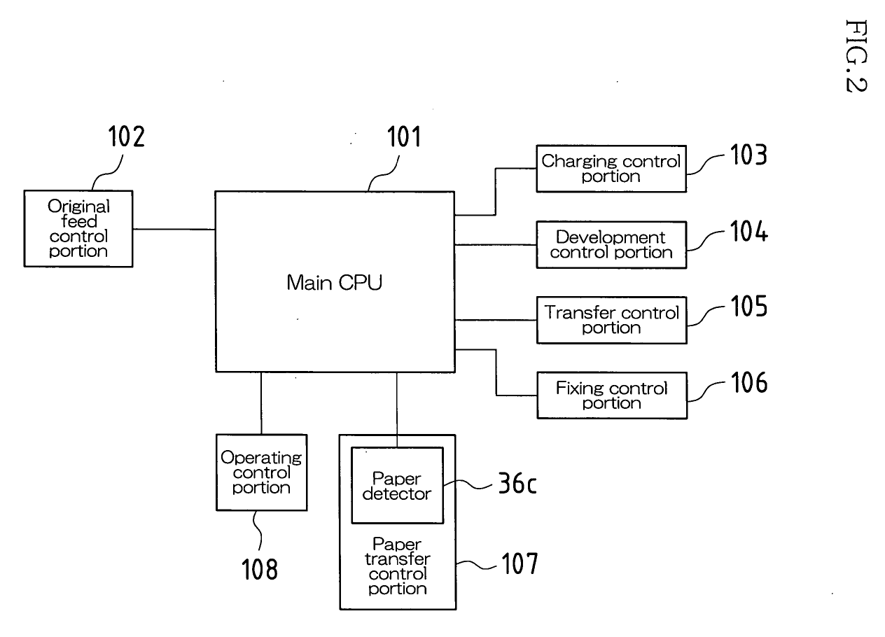

FIG. 2 is a functional block diagram that shows the basic configuration of the control system of the multifunction machine 1.

A main CPU 101 is provided in the multifunction machine 1 for performing integrated control of the included devices (the scanner portion 2, the image forming portion 3, and the automatic original feed portion 4), and bi-directionally connected to this main CPU 101 are an original feed control portion 102 that controls automatic feed of an original, a charging control portion 103 that controls each portion of the image forming portion 3, a development control portion 104, a transfer control portion 105, a fixing control portion 106, and a paper transport control portion 107 provided with the paper detector 36c that detects an edge portion of the paper. Also connected to the main CPU 101 is an operating control portion 108 that outputs a signal from an operating panel portion not shown in the figure with which an operator performs an input operation, and that allows a display operation to be performed on the operating panel portion according to the signal from the main CPU 101.

—Description of the State of the Recording Paper when Multi-Feeding Occurs in the Recording Paper Feed Portion—

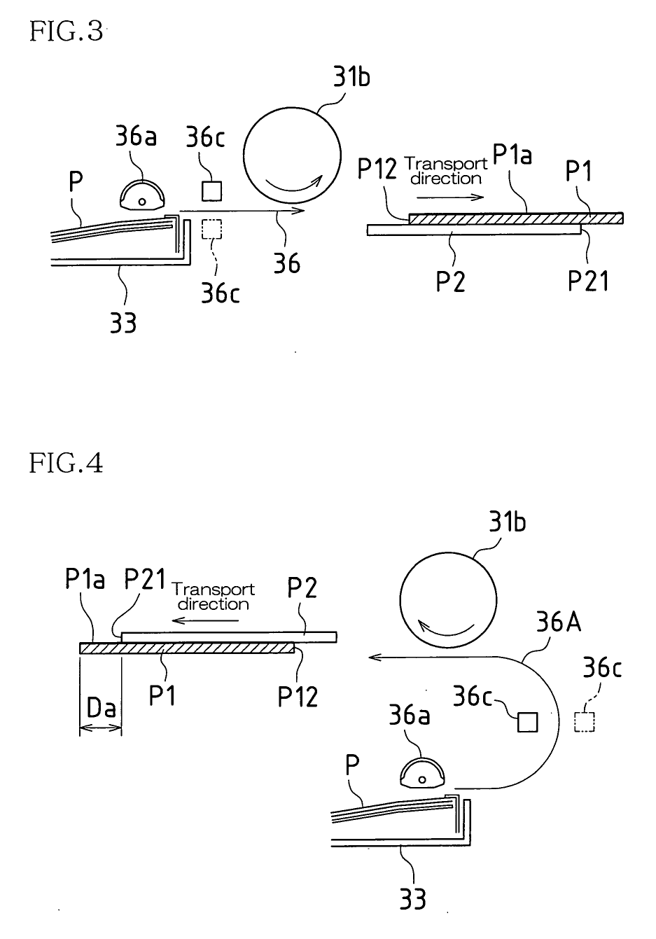

FIG. 3 is a schematic view that shows how recording paper housed in the paper cassette 33 is transported to the photosensitive drum 31b of the image forming portion 3 in the multifunction machine 1 having the above-described configuration.

When recording paper P has been supplied successively from the upper portion of the paper cassette 33 by the pickup roller 36a, because the main transport path 36 is configured with a straight path, even in the case that multi-feeding has occurred when feeding recording paper, because a multi-fed recording paper P2 is positioned on the bottom side of a recording paper P1 for which recording should be performed, and a recording face (image forming face) P1a of the recording paper P1 for which recording should be performed faces the photosensitive drum 31b, it is possible to form an image on the recording paper P1.

FIG. 4 schematically shows a case in which the configuration is somewhat different from the multifunction machine 1 with the configuration described above. The main transport path 36 from the paper cassette 33 to the photosensitive drum 31b is not formed in a straight path, but a U-shaped reverse transport path 36A.

In this configuration, when recording paper P has been supplied successively from the upper portion of the paper cassette 33 by the pickup roller 36a, because the main transport path is configured by the U-shaped reverse transport path 36A, in the case that multi-feeding has occurred when feeding recording paper, due to vertical reversal the multi-fed recording paper P2 is positioned on the top side of the recording paper P1 for which recording should be performed, and the multi-fed recording paper P2 is positioned between the recording face (image forming face) P1a of the recording paper P1 for which recording should be performed and the photosensitive drum 31b. Accordingly, in this case it is not possible to perform good image formation on the recording paper P1.

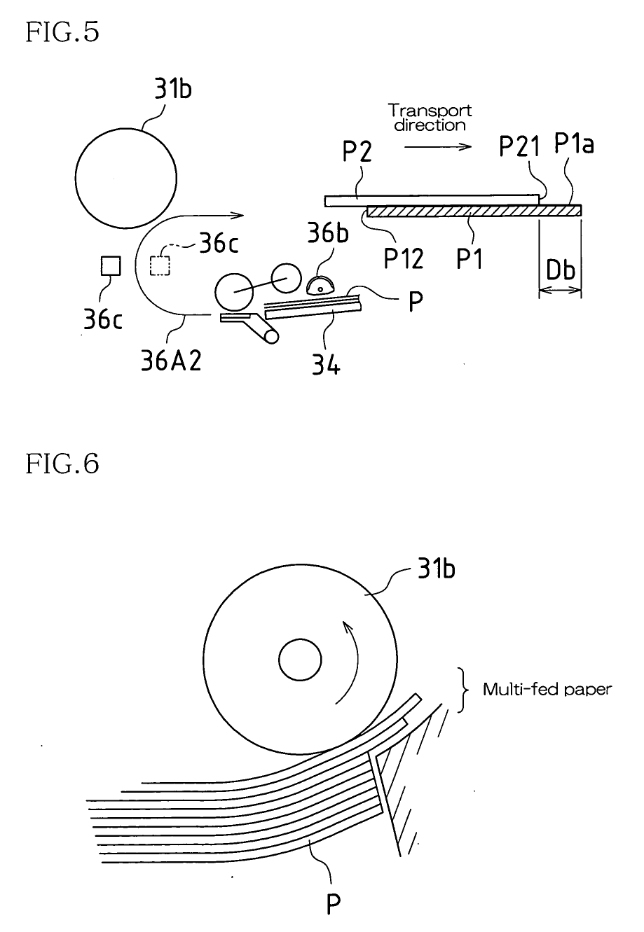

FIG. 5 shows how recording paper P placed on the manual tray 34 is transported to the photosensitive drum 31b, and like FIG. 4, shows a structure in which reverse transport is performed by a U-shaped reverse transport path 36A2.

Accordingly, in this case as well, as in the case of reverse feed shown in FIG. 4, when multi-feeding has occurred, due to vertical reversal the multi-fed recording paper P2 is positioned on the top side of the recording paper P1 for which recording should be performed, and the multi-fed recording paper P2 is positioned between the recording face (image forming face) P1a of the recording paper P1 for which recording should be performed and the photosensitive drum 31b. Accordingly, in this case as well it is not possible to perform good image formation on the recording paper P1.

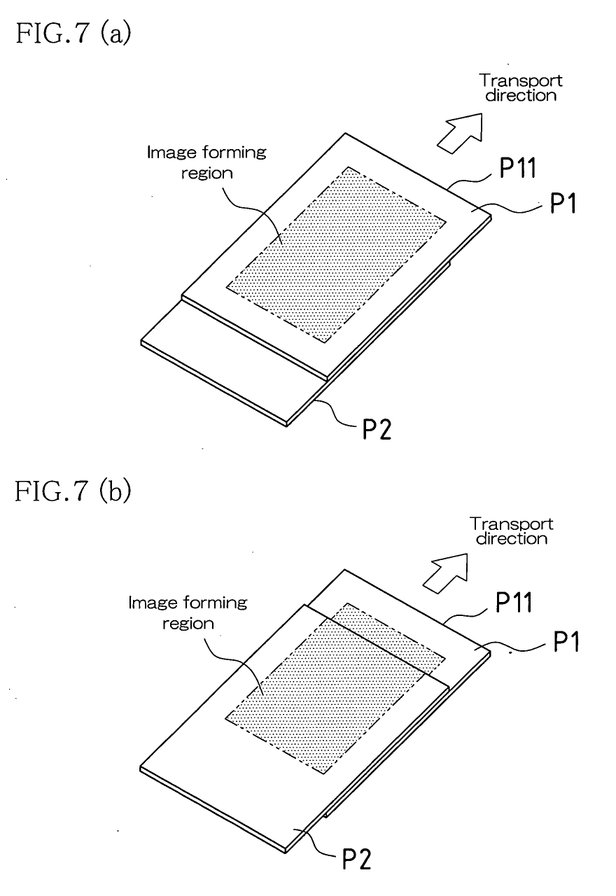

FIG. 6 shows a state in which recording paper has been multi-fed when recording paper P stored in the paper cassette 33 is supplied by a pickup roller 36a. FIG. 7(a) shows a state in which an image has been formed on recording paper that has been multi-fed. FIG. 7(b) shows another state in which an image has been formed on recording paper that has been multi-fed.

FIG. 7(a) shows an instance in which top-intake and straight transport have been performed (the instance shown in FIG. 3), for example, and because the recording paper P2 that has been multi-fed is positioned below the recording paper P1 for which recording should be performed (the side opposite to the image forming portion), recording can be performed on the recording paper P1 for which recording should be performed. Also, because position matching of a leading edge portion P11 of the recording paper P1 is performed by the registration rollers 36d provided on the downstream side of the photosensitive drum 31b, good image formation can be performed for the recording paper P1.

FIG. 7(b) shows an instance in which top-intake and reverse feed have been performed (the instance shown in FIGS. 4 and 5), for example, and because the recording paper P2 that has been multi-fed is positioned above the recording paper P1 for which recording should be performed (the side of the image forming portion), an image is mainly formed on the second page of recording paper P2 that has been multi-fed. In this case, matching of the leading edge of the recording paper is performed by the registration rollers 36d provided on the downstream side of the photosensitive drum 31b, but because the leading edge adjustment at the registration rollers 36d is performed at the leading edge portion P11 of the recording paper P1 for which recording should be performed, an image is formed across the first page of recording paper P1 and the second page of recording paper P2 as shown in the figure, leading to wasteful consumption of recording paper, toner, ink, and the like.

Following is a description of examples of an image forming operation when multi-feeding occurs in the image forming portion 3, with reference to the state of the recording paper when multi-feeding has occurred in the recording paper feed portion described above.

### EXAMPLE 1

Example 1 is an example of an image forming operation when multi-feeding occurs according to the main transport path 36 with a straight path configuration shown in FIG. 3.

That is, in the image forming portion 3 provided with the main transport path 36 having a straight path configuration, even when multi-feeding is detected, as shown in FIG. 3, the multi-fed recording paper P2 is not positioned between the recording paper P1 for which recording should be performed and the photosensitive drum 31b, and so in this case the operation that forms an image on the recording paper P1 continues as usual. In this case, the multi-fed recording paper P2 is only passed with the recording paper P1, and afterward the recording paper P2 is reused.

Next is a description of multi-feeding detection.

In the present embodiment, a new detection portion only for detecting multi-feeding is not provided; a paper detector 36c for detecting jams and the like is also used for detecting multi-feeding by detecting the leading edge portion and the trailing edge portion of the recording paper. This paper detector 36c is configured by a reflecting-type photo coupler, for example, and detects multi-feeding by detecting a shadow or the like of an edge portion of multi-fed recording paper after detecting the leading edge portion of the recording paper and before detecting the trailing edge portion. The inventors of the present invention have confirmed through testing and the like that multi-feeding of the recording paper can be reliably detected even when the paper detector 36c is also used as the multi-feeding detection portion.

In Example 1, as shown in FIG. 3, in the case that the paper detector 36c is positioned on the top side of the main transport path 36 having a straight path configuration (shown by a solid line in the figure), multi-feeding is detected by detecting a trailing edge portion P12 of the recording paper P1 for which recording should be performed. On the other hand, in the case that the paper detector 36c is positioned on the bottom side of the main transport path 36 having a straight path configuration (shown by an imaginary line in the figure), multi-feeding is detected by detecting a leading edge portion P21 of the multi-fed recording paper P2.

Also, because the paper detector 36c for detecting multi-feeding is disposed on the upstream side of the photosensitive drum 31b, it is possible to detect multi-feeding of the recording paper before it arrives at the photosensitive drum 31b. Accordingly, it is possible to judge whether or not image formation will continue as-is before an image is actually formed on the recording paper, and when continuing as-is, by performing control suitable for the multi-fed state, it is possible to obtain a good image even in the case that an image has been formed. This sort of judgment and control is executed by the paper transport control portion 107 shown in FIG. 2 based on the results of detection by the paper detector 36c.

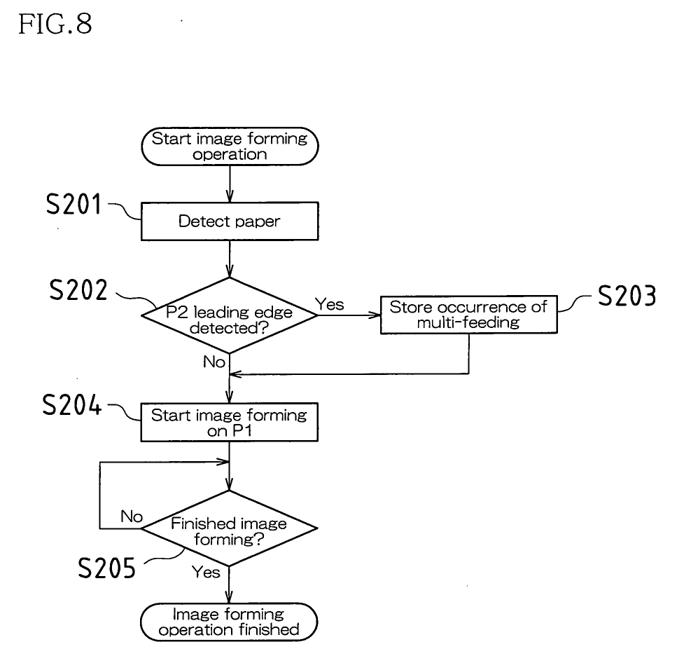

FIG. 8 is an overall flowchart of the image forming operation when multi-feeding occurs in Example 1. Here, a configuration is adopted is which the paper detector 36c is positioned on the bottom side of the main transport path 36 (shown by an imaginary line in FIG. 3). Accordingly, by detecting the leading edge portion P21 of the multi-fed recording paper P2, it is possible to detect multi-feeding before starting to form an image on the recording paper P1 for which recording should be performed.

As shown in FIG. 8, first, paper detection is performed by the paper detector 36c (Step S201). Then, it is judged whether or not the leading edge portion P21 of the multi-fed recording paper P2 has also been detected in succession to the recording paper P1 for which recording should be performed (Step S202). If it has been detected, then the operation advances to Step S203, and if it has not been detected, then the operation advances to Step S204.

In the case that multi-feeding has been detected, the occurrence of multi-feeding is stored (Step S203), and the operation advances to Step S204 in order to continue the image forming operation as-is on the recording paper P1 for which recording should be performed.

Then, formation of an image on the recording paper P1 for which recording should be performed is started (Step S204), afterward it is judged whether or not image formation has finished (Step S205), and this judgment is repeated until image formation is finished.

### EXAMPLE 2

Example 2 is an example of the image forming operation when multi-feeding occurs according to the U-shaped reverse transport path 36A shown in FIG. 4 and the U-shaped reverse transport path 36A2 shown in FIG. 5.

That is, when adopting a configuration in which the image forming portion 3 is provided with the U-shaped reverse transport path 36A or the U-shaped reverse transport path 36A2 instead of the main transport path 36 having a straight path configuration, in the case that multi-feeding has been detected, when the multi-fed recording paper P2 and the recording paper P1 for which recording should be performed make contact with the photosensitive drum 31b as shown in FIGS. 4 and 5, the recording face (image forming face) P1a of the recording paper P1 for which recording should be performed is stacked below the multi-fed recording paper P2. That is, the multi-fed recording paper P2 becomes an obstacle between the recording face (image forming face) P1a of the recording paper P1 for which recording should be performed and the photosensitive drum 31b. Accordingly, in that case the operation that forms an image on the recording paper P1 is stopped.

In Example 2, in the case that recording paper is supplied from the paper cassette 33 shown in FIG. 4 and the paper detector 36c is positioned on the left side of the reverse transport path 36A (shown by a solid line in FIG. 4), multi-feeding is detected by detecting the trailing edge portion P12 of the recording paper P1. On the other hand, in the case that the paper detector 36c is positioned on the right side of the reverse transport path 36A (shown by an imaginary line in FIG. 4), multi-feeding is detected by detecting the leading edge portion P21 of the multi-fed recording paper P2.

In the case that recording paper is supplied from the manual tray 34 shown in FIG. 5 and the paper detector 36c is positioned on the left side of the reverse transport path 36A2 (shown by a solid line in FIG. 5), multi-feeding is detected by detecting the leading edge portion P21 of the multi-fed recording paper P2. On the other hand, in the case that the paper detector 36c is positioned on the right side of the reverse transport path 36A2 (shown by an imaginary line in FIG. 5), multi-feeding is detected by detecting the trailing edge portion P12 of the recording paper P1.

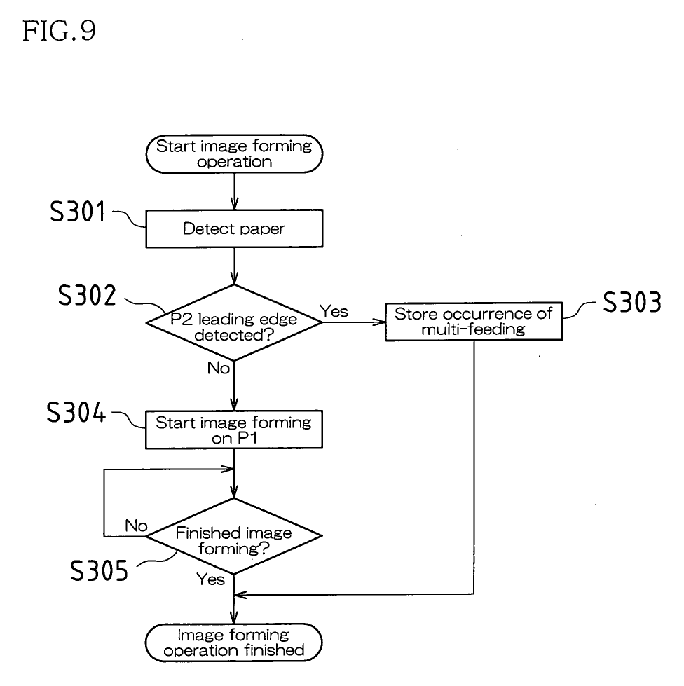

FIG. 9 is an overall flowchart of the image forming operation when multi-feeding occurs in Example 2. Here, a configuration is adopted in which the paper detector 36c is positioned on the right side of the reverse transport path 36A (shown by an imaginary line in FIG. 4). Accordingly, by detecting the leading edge portion P21 of the multi-fed recording paper P2, it is possible to detect multi-feeding before starting to form an image on the recording paper P1 for which recording should be performed.

As shown in FIG. 9, first, paper detection is performed by the paper detector 36c (Step S301). Then, it is judged whether or not the leading edge portion P21 of the multi-fed recording paper P2 has also been detected in succession to the recording paper P1 for which recording should be performed (Step S302). If it has been detected, then the operation advances to Step S303, and if it has not been detected, then the operation advances to Step S304.

In the case that multi-feeding has not been detected, formation of an image on the recording paper P1 for which recording should be performed is started (Step S304), afterward it is judged whether or not image formation has finished (Step S305), and this judgment is repeated until image formation is finished.

In the case that multi-feeding has been detected, the occurrence of multi-feeding is stored (Step S303), image formation on the recording paper P1 for which recording should be performed is suspended and the image forming operation is finished.

### EXAMPLE 3

Example 3 is another example of the image forming operation when multi-feeding occurs according to the U-shaped reverse transport path 36A shown in FIG. 4 and the U-shaped reverse transport path 36A2 shown in FIG. 5.

That is, when adopting a configuration in which the image forming portion 3 is provided with the U-shaped reverse transport path 36A or the U-shaped reverse transport path 36A2 instead of the main transport path 36 having a straight path configuration, in the case that multi-feeding has been detected, as shown in FIGS. 4 and 5, the multi-fed recording paper P2 becomes an obstacle between the recording face (image forming face) P1a of the recording paper P1 for which recording should be performed and the photosensitive drum 31b. Accordingly, in this case it is not possible to form an image on the recording paper P1. However, it is possible to form an image on the multi-fed recording paper P2. Accordingly, in Example 3, an image is not formed on the recording paper P1 for which recording should be performed, and the operation forming an image on the multi-fed recording paper P2 is continued.

In this case, as shown in FIGS. 4 and 5, it is necessary to delay the timing of image formation by the amount of a displacement length Da (see FIG. 4) or Db (FIG. 5) of the stacking of the recording paper P1 and the recording paper P2. Because detection of multi-feeding can be performed by detecting the leading edge portion P21 of the multi-fed recording paper P2 at the position where the paper detector 36c is disposed (the position shown by an imaginary line in FIG. 4, and the position shown by a solid line in FIG. 5), it is possible to form an image on the recording paper P2 by adjusting the position of the leading edge portion of the multi-fed recording paper P2 based on the timing of this detection. This sort of position adjustment control is executed with the paper transport control portion 107 shown in FIG. 2.

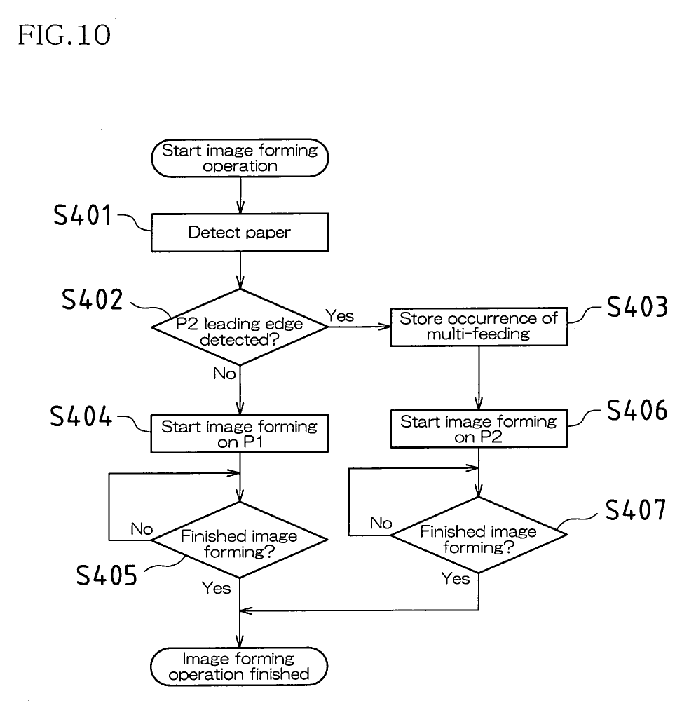

FIG. 10 is an overall flowchart of the image forming operation when multi-feeding occurs in Example 3. Here, a configuration is adopted in which the paper detector 36c is positioned on the right side of the reverse transport path 36A (shown by an imaginary line in FIG. 4). Accordingly, by detecting the leading edge portion P21 of the multi-fed recording paper P2, it is possible to detect multi-feeding before starting to form an image on the recording paper P1 for which recording should be performed.

As shown in FIG. 10, first, paper detection is performed by the paper detector 36c (Step S401). Then, it is judged whether or not the leading edge portion P21 of the multi-fed recording paper P2 has also been detected in succession to the recording paper P1 for which recording should be performed (Step S402). If it has been detected, then the operation advances to Step S403, and if it has not been detected, then the operation advances to Step S404.

In the case that multi-feeding has not been detected, formation of an image on the recording paper P1 for which recording should be performed is started (Step S404), afterward it is judged whether or not image formation has finished (Step S405), and this judgment is repeated until image formation is finished.

In the case that multi-feeding has been detected, the occurrence of multi-feeding is stored (Step S403), and next image formation on the multi-fed recording paper P2 is started (Step S406). At this time, the timing for starting image formation is delayed according to the displacement length Da of the stacking of the recording paper P1 and the recording paper P2. Afterward it is judged whether or not image formation has finished (Step S407), and this judgment is repeated until image formation is finished.

### EXAMPLE 4

In Examples 1 and 3, even if multi-feeding has occurred, the image forming operation continues in a multi-fed state. In this case, the thickness of the paper increases to the extent that the recording paper is multi-fed, and so in the image forming portion 3 it is necessary to perform image formation control that takes this into consideration.

Consequently, in Example 4, in the case that image formation is performed in a multi-fed state, the transfer bias when forming an image is elevated above normal (when there is one page of paper) by controlling the charging control portion 103 shown in FIG. 2. Thus, the toner on the photosensitive drum 31b is stably transferred to the recording paper even for a halftone image or the like, and so stable image formation can be performed and it is possible to obtain a good image.

Also, in Example 4, in the case that image formation is performed in a multi-fed state, the fixing temperature is elevated above normal (when there is one page of paper) by controlling the fixing control portion 106 shown in FIG. 2. Thus, stable fixing in the fixing apparatus 39 becomes possible, and a good image can be obtained.

### EXAMPLE 5

In Examples 1 and 3, even if multi-feeding has occurred, the image forming operation continues in a multi-fed state. In this case, the length of the recording paper is apparently lengthened to the extent that the recording paper is multi-fed, and so as a result of the increased length of the recording paper (that is, the time that passes due to detection of the leading edge portion and the trailing edge portion of the recording paper by the paper detector 36c), this is judged as the occurrence of a jam by the main CPU 101, and an emergency stop of the image forming operation is performed. Accordingly, in the main CPU 101, it is necessary to perform image formation control that takes this into consideration.

Consequently, in Example 5, in the case that image formation is continued in a multi-fed state even when multi-feeding has occurred, the detection information of the trailing edge of the recording paper from the paper detector 36c is treated as void. That is, even if the time that passes due to detection of the leading edge portion and the trailing edge portion of the recording paper by the paper detector 36c becomes longer than a reference time set in an internal portion in advance that is used for judging a jammed state, this is ignored. Thus, it is possible to continue image formation even in a multi-fed state.

Also, in Example 5, a configuration may be adopted in which, in the case that image formation is continued in a multi-fed state even when multi-feeding has occurred, the reference time set in an internal portion in advance that is used for judging a jammed state is changed longer to a second reference time by a predetermined length, and jam judgment is performed as usual. Here, in the case that feed of recording paper from the paper cassette 33 or the manual tray 34 is performed in a normal state without multi-feeding, it is necessary to set the second reference time to a time shorter than the interval from the time that the leading edge of the initial recording paper passes the paper detector 36c until the time that the leading edge of the next recording paper passes the paper detector 36c. This is because when setting this time to a longer time, it is possible that a jam will not be able to be detected even if it actually occurs. In this manner, by changing the reference time to the second reference time, it becomes possible to form an image in a multi-fed state, and a jam can be detected when it occurs.

### EXAMPLE 6

In Example 6, a configuration has been adopted in which, in the case that multi-feeding has been detected in the manner of above Examples 1 through 5, an operator is notified that multi-feeding has occurred.

As a notification method, a configuration may be adopted in which an error message or the like that multi-feeding has occurred is displayed on a display panel provided in an unshown operating panel portion of the multifunction machine 1. It is also possible to notify the operator by emitting a buzzer sound from a built-in buzzer or the like not shown in the figure, or emitting an electronic sound. It is more effective if notification is made with both the display of an error message and a notification sound. Further, a configuration may be adopted in which the contents displayed on the display panel are not limited to an error message; information of recording paper for which image formation has not been performed due to multi-feeding is displayed. For example, a page of recording paper for which image formation has not been performed due to multi-feeding is displayed. Thus, because the operator can clearly understand which page requires reread and image formation to be performed, the efficiency of reread and image forming processing improves.

Also, with the present embodiment, a case is described in which an image forming apparatus was applied to a multifunction machine, but by applying an image forming apparatus to a scanner apparatus unit, copy apparatus unit, or facsimile apparatus unit, or a multifunction machine in which any two or more of these are combined, it is possible to provide an electronic equipment in which an improvement in the efficiency of image forming processing has been achieved.

The present invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes that come within the meaning and range of equivalency of the claims are intended to be embraced therein.

This application claims priority on Patent Application No. 2003-185361 filed in Japan on Jun. 27, 2003, the entire contents of which are hereby incorporated by reference. Patents and publications cited herein are hereby specifically incorporated by reference in their entirety.

### INDUSTRIAL APPLICABILITY

In the above manner, the image processing apparatus, image forming apparatus, electronic equipment, and image forming method of the present invention are very suitable for, for example, a scanner apparatus, copy apparatus, facsimile apparatus, or a multifunction machine in which two or more of these are combined.

1. An image processing apparatus comprising a paper transport system that transports paper and an image processing system that performs image forming processing for paper transported by the paper transport system, wherein
when, in the case that multi-feeding has occurred in which when a first paper is transported by the paper transport system another paper is also transported, and the other paper is not positioned between the first paper and a working portion of the image processing system, the working portion of the image processing system is allowed to operate.

2. An image forming apparatus comprising a recording paper transport system that transports recording paper and an image forming system that forms an image on recording paper transported by the recording paper transport system, wherein
when, in the case that multi-feeding has occurred in which when a first recording paper is transported by the recording paper transport system another recording paper is also transported, and the other recording paper is not positioned between the first recording paper and an image forming portion of the image forming system, image forming processing for the first recording paper by the image forming system is continued.

3. An image forming apparatus provided with a movable feed member that supplies recording paper by making contact with recording paper that has been placed on a placement stage and extracting that recording paper from the placement stage with frictional force between the feed member and the contacted recording paper, and an image forming system that forms an image on the recording paper supplied by the feed member, wherein
when, in the case that multi-feeding has occurred in which when a first recording paper is transported by the feed member another recording paper is also supplied, and the contact face of the first recording paper contacted by the feed member is the image forming face, image forming processing for the first recording paper by the image forming system is continued.

4. An image forming apparatus provided with a movable feed member that supplies recording paper by making contact with recording paper that has been placed on a placement stage and extracting that recording paper from the placement stage with frictional force between the feed member and the contacted recording paper, and an image forming system that forms an image on the recording paper supplied by the feed member, wherein
when, in the case that multi-feeding has occurred in which when a first recording paper is transported by the feed member another recording paper is also supplied, and the contact face of the first recording paper contacted by the feed member is not the image forming face, image forming processing for the other recording paper by the image forming system is continued.

5. An image forming apparatus comprising a recording paper transport system that transports recording paper and an image forming system that forms an image on recording paper transported by the recording paper transport system, wherein
when, in the case that multi-feeding has occurred in which when a first recording paper is transported by the recording paper transport system another recording paper is also transported, and the other recording paper is positioned between the first recording paper and an image forming portion of the image forming system, image forming processing for the first recording paper by the image forming system is prohibited.

6. An image forming apparatus provided with a movable feed member that supplies recording paper by making contact with recording paper that has been placed on a placement stage and extracting that recording paper from the placement stage with frictional force between the feed member and the contacted recording paper, and an image forming system that forms an image on the recording paper supplied by the feed member, wherein
when, in the case that multi-feeding has occurred in which when a first recording paper is transported by the feed member another recording paper is also supplied, and the contact face of the first recording paper contacted by the feed member is not the image forming face, image forming processing for the first recording paper by the image forming system is prohibited.

7. The image forming apparatus according to claim 3, wherein a detector that detects multi-feeding of the first recording paper and the other recording paper is provided between the placement stage of the recording paper and the image forming portion of the image forming system.

8. The image forming apparatus according to claim 7, wherein the detector detects multi-feeding by detecting an edge portion of the multi-fed other recording paper.

9. The image forming apparatus according to claim 2, wherein a transfer bias is increased from the normal transfer bias when performing image formation in the case that multi-feeding has occurred.

10. The image forming apparatus according to claim 2, wherein a fixing temperature is increased from the normal fixing temperature when performing image formation in the case that multi-feeding has occurred.

11. The image forming apparatus according to claim 2, wherein
a trailing edge detector is provided that detects the trailing edge of the recording paper, and
when image formation is performed in the case that multi-feeding has occurred, the detection information of the trailing edge of the recording paper from the trailing edge detector is treated as void.

12. The image forming apparatus according to claim 2, wherein
a trailing edge detector is provided that detects the trailing edge of the recording paper, and
when image formation is performed in the case that multi-feeding has occurred, a reference for judging the occurrence of defects based on the detection information of the trailing edge of the recording paper from the trailing edge detector is changed to a reference taking into consideration the extent of multi-feeding.

13. The image forming apparatus according to claim 7, wherein a notifier is provided that, in the case that multi-feeding has been detected by the detector, makes such a notification.

14. The image forming apparatus according to claim 13, wherein the notifier makes a notification of information of the recording paper for which image formation could not be performed due to multi-feeding.

15. An electronic equipment, wherein the image processing apparatus according to claim 1 is a scanner apparatus, copy apparatus, or facsimile apparatus, or a multifunction machine in which any two or more of these are combined.

16. An electronic equipment, wherein the image forming apparatus according to claim 2 is a scanner apparatus, copy apparatus, or facsimile apparatus, or a multifunction machine in which any two or more of these are combined.

17. An image forming method comprising:
a step of transporting recording paper page by page with a recording paper transport system,
a step of detecting multi-feeding by detecting another recording paper when transporting a first recording paper, and
a step of continuing an image forming operation for the first recording paper by the image forming system in the case that the other recording paper is not positioned between the first recording paper and the image forming portion of the image forming system, even in the case that multi-feeding has been detected.

18. An image forming method comprising:
a step of transporting recording paper page by page with a recording paper transport system,
a step of detecting multi-feeding by detecting another recording paper when transporting a first recording paper, and
a step of continuing an image forming operation for the other recording paper by the image forming system in the case that multi-feeding has been detected and the other recording paper is positioned between the first recording paper and the image forming portion of the image forming system.
